(19) United States
(12) Patent Application Publication
(10) Pub. No.: US 2014/0086110 A1
(43) Pub. Date: Mar. 27, 2014

(54) METHOD FOR COUNTING TIMER FOR RETRANSMISSION IN WIRELESS COMMUNICATION SYSTEM AND APPARATUS THEREFOR

(71) Applicant: LG Electronics Inc., Seoul (KR)

(72) Inventors: Sunyoung Lee, Anyang-si (KR); Sungjun PARK, Anyang-si (KR); Seungjune YI, Anyang-si (KR)

(73) Assignee: LG Electronics Inc., Seoul (KR)

(21) Appl. No.: 14/027,979

(22) Filed: Sep. 16, 2013

Related U.S. Application Data
(60) Provisional application No. 61/706,745, filed on Sep. 27, 2012.

(51) Int. Cl. H04J 3/14

(52) U.S. Cl. CPC H04J 3/14
USPC 370/280

(57) ABSTRACT

A method for operating a timer at a user equipment in a Time Division Duplex (TDD) communication system is disclosed. The present invention includes steps of configuring a DRX (Discontinuous Reception) retransmission timer; and start the DRX retransmission timer to monitor consecutive PDCCH (Physical Downlink Control CHannel) subframes, wherein the DRX retransmission timer specifies the maximum number of the consecutive PDCCH-subframes until a DL (Downlink) retransmission is received in aggregated cells.

Pursuant to 35 U.S.C. §119(e), this application claims the benefit of the U.S. Provisional Patent Application No. 61/706,745, filed on Sep. 27, 2012, which is hereby incorporated by reference as if fully set forth herein.

### BACKGROUND OF THE INVENTION

1. Field of the Invention

The present invention relates to a wireless communication system, and more particularly, to a method for counting a timer for retransmission in the wireless communication system and an apparatus therefor.

2. Discussion of the Related Art

As an example of a wireless communication system to which the present invention is applicable, a 3rd generation partnership project (3GPP) long term evolution (LTE) communication system will be schematically described.

FIG. 1 is a schematic diagram showing a network structure of an evolved universal mobile telecommunications system (E-UMTS) as an example of a wireless communication system. The E-UMTS is an evolved form of the legacy UMTS and has been standardized in the 3GPP. In general, the E-UMTS is also called an LTE system. For details of the technical specification of the UMTS and the E-UMTS, refer to Release 7 and Release 8 of “3rd Generation Partnership Project; Technical Specification Group Radio Access Network”.

Referring to FIG. 1, the E-UMTS includes a user equipment (UE), an evolved node B (eNode B or eNB), and an access gateway (AG) which is located at an end of an evolved UMTS terrestrial radio access network (E-UTRAN) and connected to an external network. The eNB may simultaneously transmit multiple data streams for a broadcast service, a multicast service and/or a unicast service.

One or more cells may exist per eNB. The cell is set to operate in one of bandwidths such as 1.25, 2.5, 5, 10, 15, and 20 MHz and provides a downlink (DL) or uplink (UL) transmission service to a plurality of UEs in the bandwidth. Different cells may be set to provide different bandwidths. The eNB controls data transmission or reception to and from a plurality of UEs. The eNB transmits DL scheduling information of DL data to a corresponding UE so as to inform the UE of a time/frequency domain in which the DL data is supposed to be transmitted, coding, a data size, and hybrid automatic repeat and request (HARQ)-related information. In addition, the eNB transmits UL scheduling information of UL data to a corresponding UE so as to inform the UE of a time/frequency domain which may be used by the UE, coding, a data size, and HARQ-related information. An interface for transmitting user traffic or control traffic may be used between eNBs. A core network (CN) may include the AG and a network node or the like for user registration of UEs. The AG manages the mobility of a UE on a tracking area (TA) basis. One TA includes a plurality of cells.

Although wireless communication technology has been developed to LTE based on wideband code division multiple access (WCDMA), the demands and expectations of users and service providers are on the rise. In addition, considering other radio access technologies under development, new technological evolution is required to secure high competitiveness in the future. Decrease in cost per bit, increase in service availability, flexible use of frequency bands, a simplified structure, an open interface, appropriate power consumption of UEs, and the like are required.

### SUMMARY OF THE INVENTION

Accordingly, the present invention is directed to a method for counting a timer for retransmission in a wireless communication system and an apparatus therefor that substantially obviates one or more problems due to limitations and disadvantages of the related art.

An object of the present invention is to provide to a method for counting a timer for retransmission in a wireless communication system and an apparatus therefor.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, to a method for operating a timer at a user equipment in a Time Division Duplex (TDD) communication system according to the present invention includes steps of configuring a DRX (Discontinuous Reception) retransmission timer and starting the DRX retransmission timer to monitor consecutive PDCCH (Physical Downlink Control CHannel) subframes, wherein the DRX retransmission timer specifies the maximum number of the consecutive PDCCH-subframes until a DL (Downlink) retransmission is received in aggregated cells. Here, the PDCCH-subframes are subframes on which the one or more PDCCHs are monitored.

Preferably, the method may further comprise a step of stopping monitoring the consecutive PDCCH-subframes when the DRX retransmission timer is not running.

Preferably, the method may further comprise stopping the DRX retransmission timer when the DL retransmission is received in the aggregated cells.

Preferably, the method may further comprise starting the DRX retransmission timer when decoding of data received in the aggregated cells are failed. Further, the method can comprise receiving information on the DRX retransmission timer via a RRC (Radio Resource Control) layer signaling from the network.

More preferably, a number of consecutive PDCCH-subframes is counted regardless of a type of a subframe in the aggregated cells. Here, the type of the subframe indicates whether the subframe is a downlink subframe, a special subframe or an uplink subframe.

Further, a subframe configuration of the first cell can be different from that of the one or more second cells.

Furthermore, the PDCCH-subframes are subframes with the PDCCH in all cells except for the one or more second cells. Or, the PDCCH-subframes are subframes with the PDCCH in all cells except for at least one cell configured with an identity of a scheduling cell

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a diagram showing a network structure of an Evolved Universal Mobile Telecommunications System (E-UMTS) as an example of a wireless communication system.

FIG. 2 is a diagram conceptually showing a network structure of an evolved universal terrestrial radio access network (E-UTRAN).

FIG. 3 is a diagram showing a control plane and a user plane of a radio interface protocol between a UE and an E-UTRAN based on a 3rd generation partnership project (3GPP) radio access network standard.

FIG. 4 is a diagram showing physical channels used in a 3GPP system and a general signal transmission method using the same.

FIG. 5 is a diagram showing the structure of a radio frame used in a Long Term Evolution (LTE) system.

FIG. 6 is a diagram showing the structure of a radio frame used in a LTE TDD (Time Division Duplex) system.

FIG. 7 is a conceptual diagram of a carrier aggregation scheme;

FIG. 8 is a diagram showing a general transmission and reception method using a paging message.

FIG. 9 is a diagram showing a concept DRX (Discontinuous Reception).

FIG. 10 is a diagram showing a method for a DRX operation in the LTE system.

FIG. 11 illustrates an application example of cross-carrier scheduling.

FIG. 12 illustrates a problem encountered with a conventional drx-RetransmissionTimer, in the case where cross-carrier scheduling is applied and a different UL/DL configuration is used for each serving cell.

FIG. 13 illustrates an example of counting PDCCH-subframes to activate drx-RetransmissionTimer according to an embodiment of the present invention.

FIG. 14 is a block diagram of a communication apparatus according to an embodiment of the present invention.

### DETAILED DESCRIPTION OF THE INVENTION

The configuration, operation and other features of the present invention will be understood by the embodiments of the present invention described with reference to the accompanying drawings. The following embodiments are examples of applying the technical features of the present invention to a 3rd generation partnership project (3GPP) system.

Although the embodiments of the present invention are described using a long term evolution (LTE) system and a LTE-advanced (LTE-A) system in the present specification, they are purely exemplary. Therefore, the embodiments of the present invention are applicable to any other communication system corresponding to the above definition. In addition, although the embodiments of the present invention are described based on a frequency division duplex (FDD) scheme in the present specification, the embodiments of the present invention may be easily modified and applied to a half-duplex FDD (H-FDD) scheme or a time division duplex (TDD) scheme.

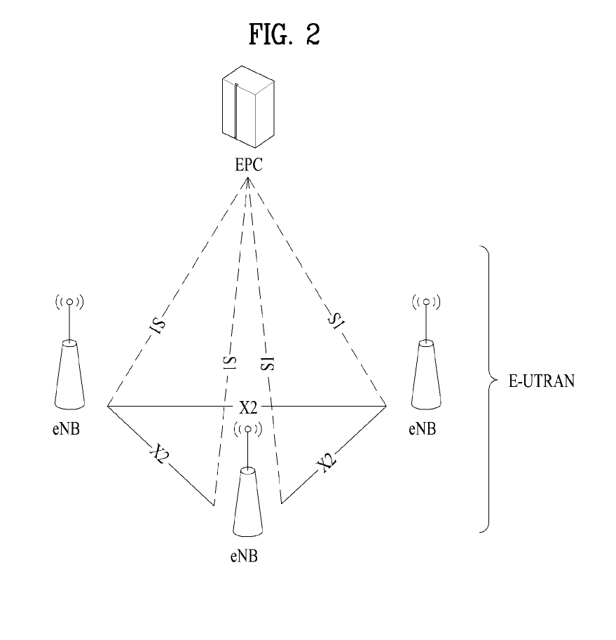

FIG. 2 is a diagram conceptually showing a network structure of an evolved universal terrestrial radio access network (E-UTRAN). An E-UTRAN system is an evolved form of a legacy UTRAN system. The E-UTRAN includes cells (eNB) which are connected to each other via an X2 interface. A cell is connected to a user equipment (UE) via a radio interface and to an evolved packet core (EPC) via an S1 interface.

The EPC includes a mobility management entity (MME), a serving-gateway (S-GW), and a packet data network-gateway (PDN-GW). The MME has information about connections and capabilities of UEs, mainly for use in managing the mobility of the UEs. The S-GW is a gateway having the E-UTRAN as an end point, and the PDN-GW is a gateway having a packet data network (PDN) as an end point.

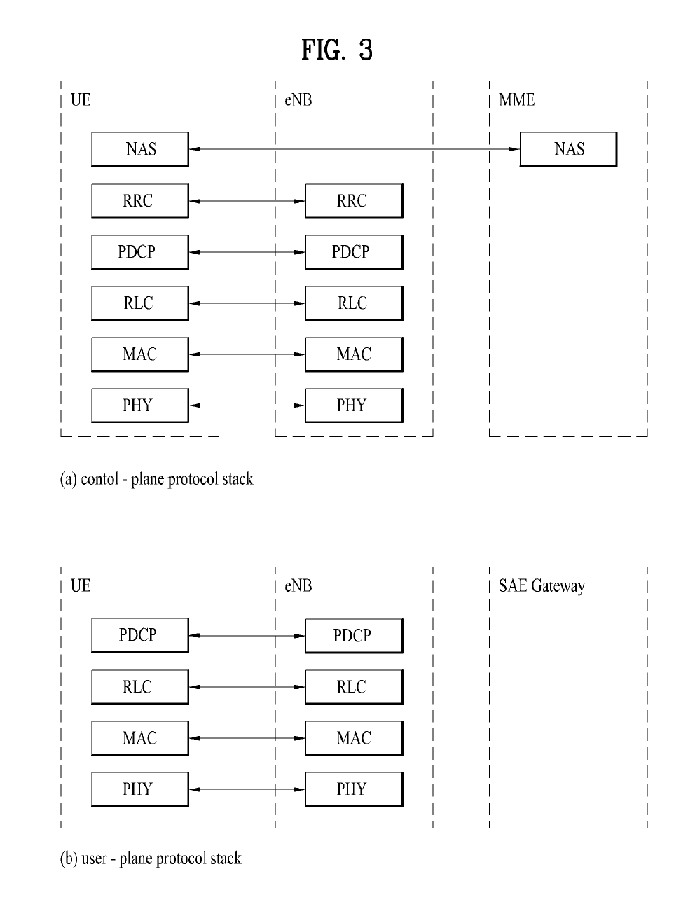

FIG. 3 is a diagram showing a control plane and a user plane of a radio interface protocol between a UE and an E-UTRAN based on a 3GPP radio access network standard. The control plane refers to a path used for transmitting control messages used for managing a call between the UE and the E-UTRAN. The user plane refers to a path used for transmitting data generated in an application layer, e.g., voice data or Internet packet data.

A physical (PHY) layer of a first layer provides an information transfer service to a higher layer using a physical channel. The PHY layer is connected to a medium access control (MAC) layer located on the higher layer via a transport channel. Data is transported between the MAC layer and the PHY layer via the transport channel. Data is transported between a physical layer of a transmitting side and a physical layer of a receiving side via physical channels. The physical channels use time and frequency as radio resources. In detail, the physical channel is modulated using an orthogonal frequency division multiple access (OFDMA) scheme in downlink and is modulated using a single carrier frequency division multiple access (SC-FDMA) scheme in uplink.

The MAC layer of a second layer provides a service to a radio link control (RLC) layer of a higher layer via a logical channel. The RLC layer of the second layer supports reliable data transmission. A function of the RLC layer may be implemented by a functional block of the MAC layer. A packet data convergence protocol (PDCP) layer of the second layer performs a header compression function to reduce unnecessary control information for efficient transmission of an Internet protocol (IP) packet such as an IP version 4 (IPv4) packet or an IP version 6 (IPv6) packet in a radio interface having a relatively small bandwidth.

A radio resource control (RRC) layer located at the bottom of a third layer is defined only in the control plane. The RRC layer controls logical channels, transport channels, and physical channels in relation to configuration, re-configuration, and release of radio bearers (RBs). An RB refers to a service that the second layer provides for data transmission between the UE and the E-UTRAN. To this end, the RRC layer of the UE and the RRC layer of the E-UTRAN exchange RRC messages with each other.

One cell of the eNB is set to operate in one of bandwidths such as 1.25, 2.5, 5, 10, 15, and 20 MHz and provides a downlink or uplink transmission service to a plurality of UEs in the bandwidth. Different cells may be set to provide different bandwidths.

Downlink transport channels for transmission of data from the E-UTRAN to the UE include a broadcast channel (BCH) for transmission of system information, a paging channel (PCH) for transmission of paging messages, and a downlink shared channel (SCH) for transmission of user traffic or control messages. Traffic or control messages of a downlink multicast or broadcast service may be transmitted through the downlink SCH and may also be transmitted through a separate downlink multicast channel (MCH).

Uplink transport channels for transmission of data from the UE to the E-UTRAN include a random access channel (RACH) for transmission of initial control messages and an uplink SCH for transmission of user traffic or control messages. Logical channels that are defined above the transport channels and mapped to the transport channels include a broadcast control channel (BCCH), a paging control channel (PCCH), a common control channel (CCCH), a multicast control channel (MCCH), and a multicast traffic channel (MTCH).

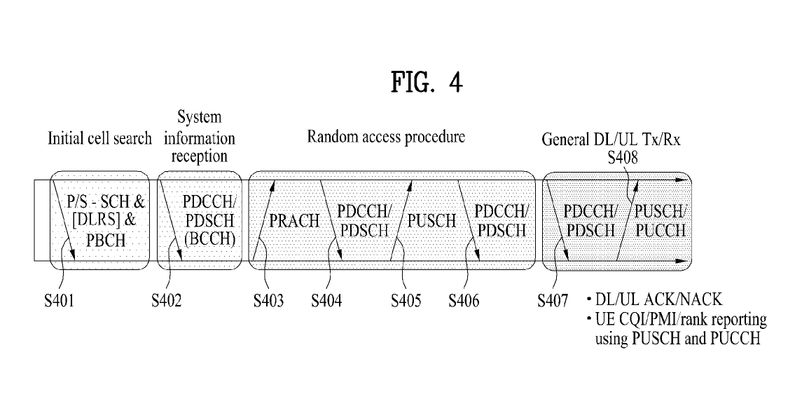

FIG. 4 is a diagram showing physical channels used in a 3GPP system and a general signal transmission method using the same.

When a UE is powered on or enters a new cell, the UE performs an initial cell search operation such as synchronization with an eNB (S401). To this end, the UE may receive a primary synchronization channel (P-SCH) and a secondary synchronization channel (S-SCH) from the eNB to perform synchronization with the eNB and acquire information such as a cell ID. Then, the UE may receive a physical broadcast channel from the eNB to acquire broadcast information in the cell. During the initial cell search operation, the UE may receive a downlink reference signal (DL RS) so as to confirm a downlink channel state.

After the initial cell search operation, the UE may receive a physical downlink control channel (PDCCH) and a physical downlink control channel (PDSCH) based on information included in the PDCCH to acquire more detailed system information (S402).

When the UE initially accesses the eNB or has no radio resources for signal transmission, the UE may perform a random access procedure (RACH) with respect to the eNB (steps S403 to S406). To this end, the UE may transmit a specific sequence as a preamble through a physical random access channel (PRACH) (S403) and receive a response message to the preamble through the PDCCH and the PDSCH corresponding thereto (S404). In the case of contention-based RACH, the UE may further perform a contention resolution procedure.

After the above procedure, the UE may receive PDCCH/PDSCH from the eNB (S407) and may transmit a physical uplink shared channel (PUSCH)/physical uplink control channel (PUCCH) to the eNB (S408), which is a general uplink/downlink signal transmission procedure. Particularly, the UE receives downlink control information (DCI) through the PDCCH. Here, the DCI includes control information such as resource allocation information for the UE. Different DCI formats are defined according to different usages of DCI.

Control information transmitted from the UE to the eNB in uplink or transmitted from the eNB to the UE in downlink includes a downlink/uplink acknowledge/negative acknowledge (ACK/NACK) signal, a channel quality indicator (CQI), a precoding matrix index (PMI), a rank indicator (RI), and the like. In the case of the 3GPP LTE system, the UE may transmit the control information such as CQI/PMI/RI through the PUSCH and/or the PUCCH.

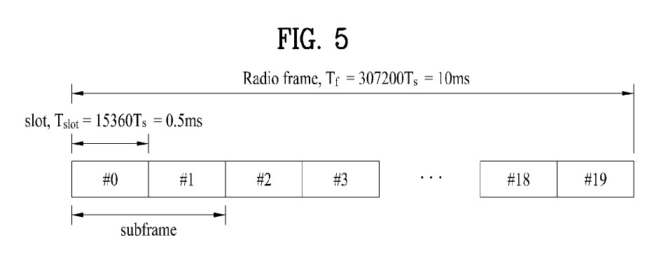

FIG. 5 is a diagram showing the structure of a radio frame used in an LTE system.

Referring to FIG. 5, the radio frame has a length of 10 ms (327200×Tₛ) and is divided into 10 subframes having the same size. Each of the subframes has a length of 1 ms and includes two slots. Each of the slots has a length of 0.5 ms (15360×Tₛ). Is denotes a sampling time, and is represented by Tₛ=1/(15 kHz×2048)=3.2552×10⁻⁸ (about 33 ns). Each of the slots includes a plurality of OFDM symbols in a time domain and a plurality of Resource Blocks (RBs) in a frequency domain. In the LTE system, one RB includes 12 subcarriers×7 (or 6) OFDM symbols. A transmission time interval (TTI) that is a unit time for transmission of data may be determined in units of one or more subframes. The structure of the radio frame is purely exemplary and thus the number of subframes included in the radio frame, the number of slots included in a subframe, or the number of OFDM symbols included in a slot may be changed in various ways.

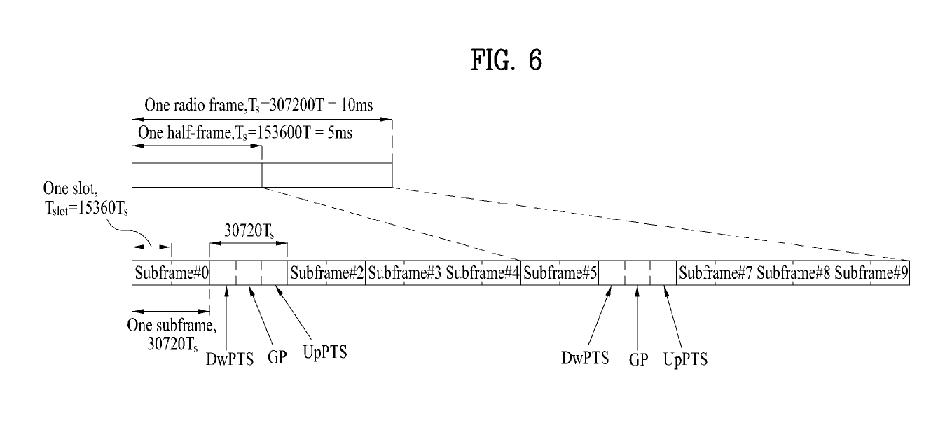

FIG. 6 is a diagram showing the structure of a radio frame used in a LTE TDD (Time Division Duplex) system.

In LTE TDD system, the radio frame includes two half frames, each of which includes normal subframes and a special subframe. The normal subframe includes two slots and the special subframe includes a downlink pilot time slot (DwPTS), a guard period (GP), and an uplink pilot time slot (UpPTS).

In the special subframe, DwPTS is used for initial cell search, synchronization or channel estimation at the user equipment. UpPTS is used to synchronize channel estimation at the base station with uplink transmission of the user equipment. In other words, DwPTS is used for downlink transmission, and UpPTS is used for uplink transmission. In particular, UpPTS is used for PRACH preamble or SRS transmission. Also, the guard period is to remove interference occurring in the uplink due to multipath delay of downlink signals between the uplink and the downlink.

The current 3GPP standard document defines the special subframe as illustrated in Table 1 below. In Table 1, Tₛ=1/(15000×2048) represents DwPTS and UpPTS, and the other region is set to the guard period.

TABLE 1

| | Normal cyclic prefix | | | Extended cyclic prefix | | |
|---|---|---|---|---|---|---|
| | in downlink | | | in downlink | | |
| | | UpPTS | | | UpPTS | |
| | | Normal | Extended | | Normal | |
| Special | | cyclic | cyclic | | cyclic | Extended |
| subframe | | prefix in | prefix | | prefix in | cyclic prefix |
| configuration | DwPTS | uplink | in uplink | DwPTS | uplink | in uplink |
| 0 | 6592 · Tₛ | 2192 · Tₛ | 2560 · Tₛ | 7680 · Tₛ | 2192 · Tₛ | 2560 · Tₛ |
| 1 | 19760 · Tₛ | | | 20480 · Tₛ | | |
| 2 | 21952 · Tₛ | | | 23040 · Tₛ | | |
| 3 | 24144 · Tₛ | | | 25600 · Tₛ | | |
| 4 | 26336 · Tₛ | | | 7680 · Tₛ | 4384 · Tₛ | 5120 · Tₛ |
| 5 | 6592 · Tₛ | 4384 · Tₛ | 5120 · Tₛ | 20480 · Tₛ | | |
| 6 | 19760 · Tₛ | | | 23040 · Tₛ | | |
| 7 | 21952 · Tₛ | | | — | — | — |
| 8 | 24144 · Tₛ | | | — | — | — |

Meanwhile, the structure of the radio frame, that is, UL/DL configuration in the TDD system is as illustrated in Table 2 below.

TABLE 2

| | Downlink- | | | | | | | | | | |
|---|---|---|---|---|---|---|---|---|---|---|---|
| | to-Uplink | | | | | | | | | | |
| Uplink- | Switch- | | | | | | | | | | |
| downlink | point | Subframe number | | | | | | | | | |
| configuration | periodicity | 0 | 1 | 2 | 3 | 4 | 5 | 6 | 7 | 8 | 9 |
| 0 | 5 ms | D | S | U | U | U | D | S | U | U | U |
| 1 | 5 ms | D | S | U | U | D | D | S | U | U | D |
| 2 | 5 ms | D | S | U | D | D | D | S | U | D | D |
| 3 | 10 ms | D | S | U | U | U | D | D | D | D | D |
| 4 | 10 ms | D | S | U | U | D | D | D | D | D | D |
| 5 | 10 ms | D | S | U | D | D | D | D | D | D | D |
| 6 | 5 ms | D | S | U | U | U | D | S | U | U | D |

In the above Table 2, D indicates a downlink subframe, U indicates an uplink subframe, and S means the special subframe. Also, the above Table 2 represents a downlink-uplink switching period of uplink/downlink subframe configuration in each system.

System information will now be described. The system information includes essential information necessary to connect a UE to an eNB. Accordingly, the UE should receive all system information before being connected to the eNB and should always have new system information. The eNB periodically transmits the system information because all UEs located in a cell should know the system information.

The system information may be divided into a master information block (MIB), a scheduling block (SB), and a system information block (SIB). The MIB enables a UE to become aware of a physical configuration of a cell, for example, a bandwidth. The SB indicates transmission information of SIBs, for example, a transmission period. The SIB is a set of associated system information. For example, a specific SIB includes only information about peripheral cells and another SIB includes only information about an uplink radio channel used by a UE.

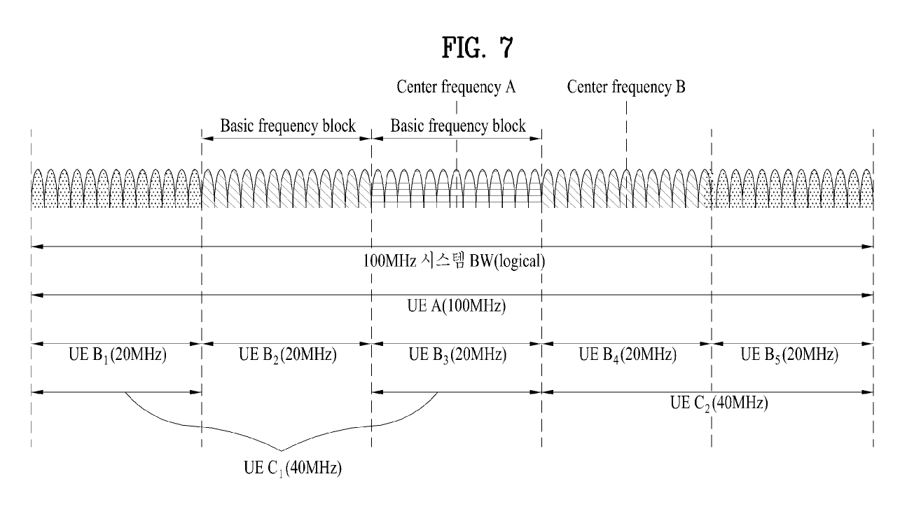

Carrier aggregation will hereinafter be described in detail. FIG. 7 exemplarily shows carrier aggregation.

Carrier aggregation refers to a method for allowing a UE to use a plurality of frequency blocks or (logical) cells, each of which is composed of uplink resources (or CCs) and/or downlink resources (or CCs), as one large logical band so as to provide a wireless communication system with a wider frequency bandwidth. For convenience of description and better understanding of the present invention, carrier aggregation will hereinafter be referred to as a component carrier (CC).

Referring to FIG. 7, the entire system bandwidth (System BW) includes a bandwidth of 100 MHz as a logical bandwidth. The entire system bandwidth (system BW) includes five component carriers (CCs) and each CC has a maximum bandwidth of 20 MHz. The CC includes one or more physically contiguous subcarriers. Although all CCs have the same bandwidth in FIG. 7, this is only exemplary and the CCs may have different bandwidths. Although the CCs are shown as being contiguous in the frequency domain in FIG. 7, FIG. 7 merely shows the logical concept and thus the CCs may be physically contiguous or separated.

Different center frequencies may be used for the CCs or one common center frequency may be used for physically contiguous CCs. For example, in FIG. 7, if it is assumed that all CCs are physically contiguous, a center frequency A may be used. If it is assumed that CCs are not physically contiguous, a center frequency A, a center frequency B and the like may be used for the respective CCs.

In the present specification, the CC may correspond to a system band of a legacy system. By defining the CC based on the legacy system, it is possible to facilitate backward compatibility and system design in a radio communication environment in which an evolved UE and a legacy UE coexist. For example, if the LTE-A system supports carrier aggregation, each CC may correspond to the system band of the LTE system. In this case, the CC may have any one bandwidth such as 1.25, 2.5, 5, 10 or 20 MHz.

In the case in which the entire system band is extended by carrier aggregation, a frequency band used for communication with each UE is defined in CC units. A UE A may use 100 MHz which is the bandwidth of the entire system band and perform communication using all five CCs. Each of UEs B₁ to B₅ may only use a bandwidth of 20 MHz and perform communication using one CC. Each of UEs C₁ and C₂ may use a bandwidth of 40 MHz and perform communication using two CCs. The two CCs may be contiguous or non-contiguous. The UE C₁ uses two non-contiguous CCs and the UE C₂ uses two contiguous CCs.

One downlink CC and one uplink CC may be used in the LTE system and several CCs may be used in the LTE-A system as shown in FIG. 7. At this time, a method of scheduling a data channel by a control channel may be divided into a linked carrier scheduling method and a cross carrier scheduling method.

More specifically, in the linked carrier scheduling method, similarly to the LTE system using a single CC, a control channel transmitted via a specific CC schedules only a data channel via the specific CC.

In contrast, in the cross carrier scheduling method, a control channel transmitted via a primary CC using a carrier indicator field (CIF) schedules a data channel transmitted via the primary CC or another CC.

Hereinafter, an RRC state of a UE and an RRC connection method will be described.

The RRC state indicates whether the RRC layer of the UE is logically connected to the RRC layer of the E-UTRAN. When the RRC connection is established, the UE is in a RRC_CONNECTED state. Otherwise, the UE is in a RRC_IDLE state.

The E-UTRAN can effectively control UEs because it can check the presence of RRC_CONNECTED UEs on a cell basis. On the other hand, the E-UTRAN cannot check the presence of RRC_IDLE UEs on a cell basis and thus a CN manages RRC_IDLE UEs on a TA basis. A TA is an area unit larger than a cell. That is, in order to receive a service such as a voice service or a data service from a cell, the UE needs to transition to the RRC_CONNECTED state.

In particular, when a user initially turns a UE on, the UE first searches for an appropriate cell and camps on the cell in the RRC_IDLE state. The RRC_IDLE UE transitions to the RRC_CONNECTED state by performing an RRC connection establishment procedure only when the RRC_IDLE UE needs to establish an RRC connection. For example, when uplink data transmission is necessary due to call connection attempt of a user or when a response message is transmitted in response to a paging message received from the E-UTRAN, the RRC_IDLE UE needs to be RRC connected to the E-UTRAN.

FIG. 8 is a diagram showing a general transmission and reception method using a paging message.

Referring to FIG. 8, the paging message includes a paging record having paging cause and UE identity. Upon receiving the paging message, the UE may perform a discontinuous reception (DRX) operation in order to reduce power consumption.

In detail, a network configures a plurality of paging occasions (POs) in every time cycle called a paging DRC cycle and a specific UE receives only a specific paging occasion and acquires a paging message. The UE does not receive a paging channel in paging occasions other than the specific paging occasion and may be in a sleep state in order to reduce power consumption. One paging occasion corresponds to one TTI.

The eNB and the UE use a paging indicator (PI) as a specific value indicating transmission of a paging message. The eNB may define a specific identity (e.g., paging-radio network temporary identity (P-RNTI)) as the PI and inform the UE of paging information transmission. For example, the UE wakes up in every DRX cycle and receives a subframe to determine the presence of a paging message directed thereto. In the presence of the P-RNTI on an L1/L2 control channel (a PDCCH) in the received subframe, the UE is aware that a paging message exists on a PDSCH of the subframe. When the paging message includes an ID of the UE (e.g., an international mobile subscriber identity (IMSI)), the UE receives a service by responding to the eNB (e.g., establishing an RRC connection or receiving system information).

Hereinafter, a DRX (Discontinuous Reception) will be described. The DRX is a method for saving of a power consumption by allowing to monitor a PDCCH discontinuously.

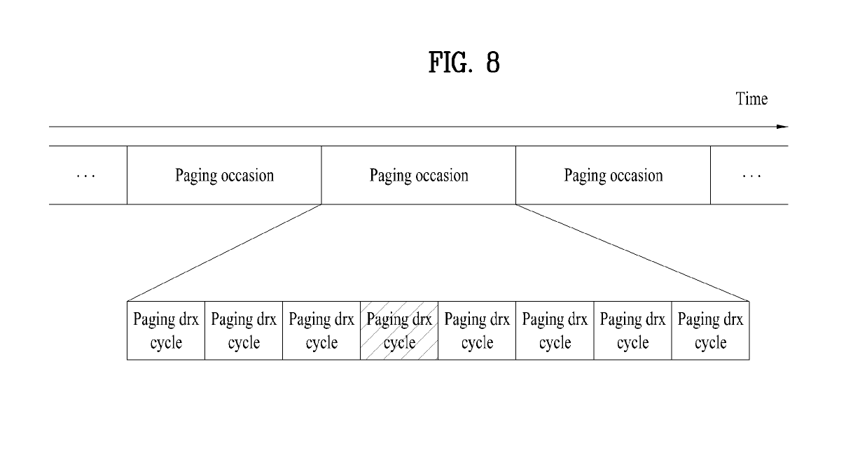

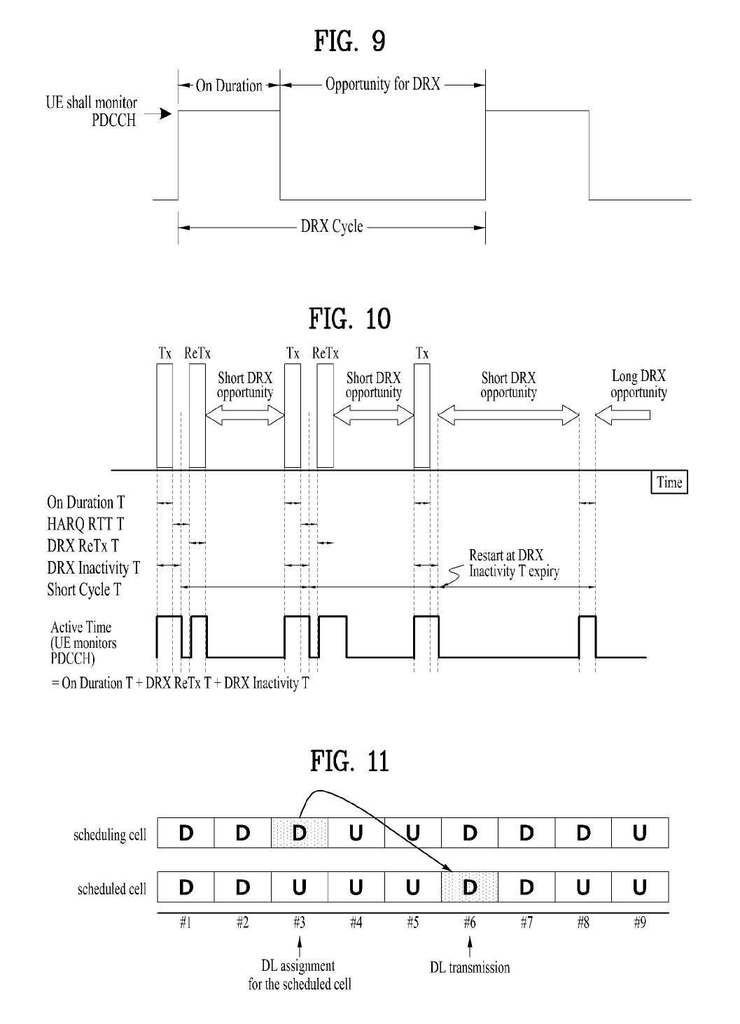

FIG. 9 is a diagram showing a concept DRX (Discontinuous Reception).

Referring to FIG. 9, if DRX is set for a UE in RRC_CONNECTED state, the UE attempts to receive a downlink channel, PDCCH, that is, performs PDCCH monitoring only during a predetermined time period, while the UE does not perform PDCCH monitoring during the remaining time period. A time period during which the UE should monitor a PDCCH is referred to as On Duration. One On Duration is defined per DRX cycle. That is, a DRX cycle is a repetition period of On Duration.

The UE always monitors a PDCCH during On Duration in one DRX cycle and a DRX cycle determines a period in which On Duration is set. DRX cycles are classified into a long DRX cycle and a short DRX cycle according to the periods of the DRX cycles. The long DRX cycle may minimize the battery consumption of a UE, whereas the short DRX cycle may minimize a data transmission delay.

When the UE receives a PDCCH during On Duration in a DRX cycle, an additional transmission or a retransmission may take place during a time period other than the On Duration. Therefore, the UE should monitor a PDCCH during a time period other than the On Duration. That is, the UE should perform PDCCH monitoring during a time period over which an inactivity managing timer, drx-InactivityTimer or a retransmission managing timer, drx-RetransmissionTimer as well as an On Duration managing timer, on DurationTimer is running.

The value of each of the timers is defined as the number of subframes. The number of subframes is counted until the value of a timer is reached. If the value of the timer is satisfied, the timer expires. The current LTE standard defines drx-InactivityTimer as a number of consecutive PDCCH-subframes after successfully decoding a PDCCH indicating an initial UL or DL user data transmission and defines drx-RetransmissionTimer as a maximum number of consecutive PDCCH-subframes for as soon as a DL retransmission is expected by the UE.

Additionally, the UE should perform PDCCH monitoring during random access or when the UE transmits a scheduling request and attempts to receive a UL grant.

A time period during which a UE should perform PDCCH monitoring is referred to as an Active Time. The Active Time includes On Duration during which a PDCCH is monitored periodically and a time interval during which a PDCCH is monitored upon generation of an event.

More specifically, the Active Time includes the time while (1) on DurationTimer or drx-InactivityTimer or drx-RetransmissionTimer or mac-ContentionResolutionTimer is running, or (2) a Scheduling Request is sent on PUCCH and is pending, or (3) an uplink grant for a pending HARQ retransmission can occur and there is data in the corresponding HARQ buffer, or (4) a PDCCH indicating a new transmission addressed to the C-RNTI of the UE has not been received after successful reception of a Random Access Response for the preamble not selected by the UE.

FIG. 10 is a diagram showing a method for a DRX operation in the LTE system. Referring to FIG. 10, the UE may be configured by RRC with a DRX functionality shall perform following operations for each TTI (that is, each subframe).

If a HARQ RTT (Round Trip Time) Timer expires in this subframe and the data of the corresponding HARQ process was not successfully decoded, the UE shall start the drx-RetransmissionTimer for the corresponding HARQ process.

Further, if a DRX Command MAC control element (CE) is received, the UE shall stop on DurationTimer and drx-InactivityTimer. The DRX Command MAC CE is a command for shifting to a DRX state, is identified by a LCID (Logical Channel ID) field of a MAC PDU (Protocol Data Unit) subheader.

Further, in case that drx-InactivityTimer expires or a DRX Command MAC CE is received in this subframe, if the Short DRX cycle is configured, the UE shall start or restart drxShortCycleTimer, and use the Short DRX Cycle. However, if the Short DRX cycle is not configured, the Long DRX cycle is used. Additionally, if drxShortCycleTimer expires in this subframe, the Long DRX Cycle is also used.

Furthermore, if the Short DRX Cycle is used and [(SFN*10)+subframe number] modulo (shortDRX-Cycle) is (drxStartOffset) modulo (shortDRX-Cycle), or if the Long DRX Cycle is used and [(SFN*10)+subframe number] modulo (longDRX-Cycle) is drxStartOffset, the UE shall start on DurationTimer.

The UE shall monitor the PDCCH for a PDCCH-subframe during the Active Time. If the PDCCH indicates a DL transmission or if a DL assignment has been configured for this subframe, the UE shall start the HARQ RTT Timer for the corresponding HARQ process and stop the drx-RetransmissionTimer for the corresponding HARQ process. If the PDCCH indicates a (DL or UL) new transmission, the UE shall start or restart drx-InactivityTimer.

Here, the PDCCH-subframe is defined as a subframe with PDCCH. That is, the PDCCH-subframe is a subframe on which the PDCCH can be transmitted. More specifically, in a FDD (frequency division duplex) system, the PDCCH-subframe represents any subframe. For full-duplex TDD (time division duplex) system, the PDCCH-subframe represents the union of downlink subframes and subframes including DwPTS of all serving cells, except serving cells that are configured with schedulingCellId (that is, the Scheduled cell). Here, the schedulingCellId indicates an identity of the scheduling cell. Further, for half-duplex TDD system, the PDCCH-subframe represents the subframes where the PCell (primary cell) is configured as a downlink subframe or a subframe including DwPTS.

Meanwhile, when not in Active Time, the UE does not perform a SRS (Sounding Reference Signal) transmission and a CSI reporting, which are triggered by the eNB.

During the above DRX operation, only the HARQ RTT Timer is fixed to 8 ms, whereas the eNB indicates the other timer values, on DurationTimer, drx-InactivityTimer, drx-RetransmissionTimer, and mac-ContentionResolutionTimer to the UE by an RRC signal. The eNB also indicates a long DRX cycle and a short DRX cycle, which represent the period of a DRX cycle, to the UE by an RRC signal.

When the UE operates using a plurality of serving cells in a Carrier Aggregation (CA) scheme, the eNB may apply cross-carrier scheduling to the UE, as stated before. That is, the eNB may transmit radio resource allocation information about a scheduled serving cell (or scheduled cell) on a PDCCH of a scheduling serving cell (or scheduling cell).

FIG. 11 illustrates an application example of cross-carrier scheduling.

Referring to FIG. 11, if an eNB uses a CA scheme for a UE using a plurality of serving cells to which different UL/DL configurations are applied, the UE may receive radio resource allocation information about a specific subframe of a scheduled cell through a scheduling cell in a subframe previous to the specific subframe. That is, a subframe in which the UE receives retransmitted downlink data from the eNB may be different from a subframe in which the UE receives a DL assignment from the eNB.

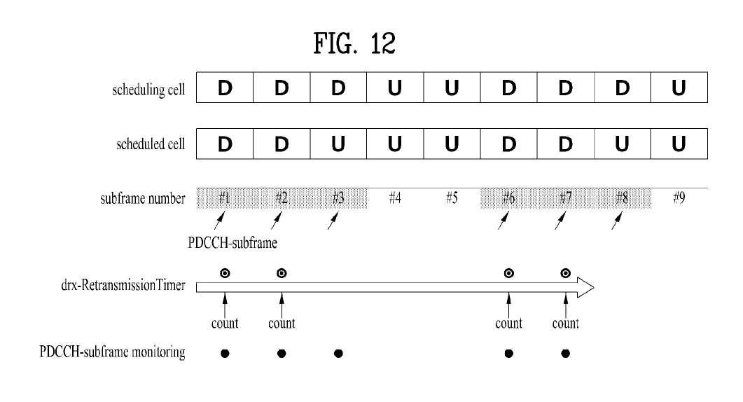

FIG. 12 illustrates a problem encountered with a conventional drx-RetransmissionTimer, in the case where cross-carrier scheduling is applied and a different UL/DL configuration is used for each serving cell.

As described before, the current LTE standard defines drx-RetransmissionTimer as the maximum number of consecutive PDCCH-subframes for as soon as a DL retransmission is expected by the UE. In other words, PDCCH-subframes counted by the conventional drx-RetransmissionTimer refer to subframes available for DL retransmission.

However, if the DRX retransmission timer is activated by counting PDCCH-subframes available for DL data retransmission according to the conventional definition of drx-RetransmissionTimer, the UE should calculate a subframe in which PDCCH monitoring is performed in order to receive retransmitted downlink data from the eNB.

For example, although subframe #3 of a scheduling cell is a PDCCH-subframe, subframe #3 of the scheduling cell is an uplink subframe unavailable for downlink data retransmission. Therefore, subframe #3 of the scheduling cell is not counted by drx-RetransmissionTimer.

Consequently, the UE may perform PDCCH monitoring for a longer time period than needed until drx-RetransmissionTimer expires, which is not preferable in terms of power consumption of the UE.

Accordingly, the present invention proposes that if an eNB performs cross-carrier scheduling for a UE, the UE counts PDCCH-subframes in which the UE may receive a DL assignment for retransmission from the eNB in order to calculate a running time of drx-RetransmissionTimer.

Or if an eNB performs cross-carrier scheduling for a UE, the UE may count PDCCH-subframes until reception of actual retransmitted downlink data or generation of actual retransmitted downlink data in order to calculate a running time of drx-RetransmissionTimer.

Specifically, if the eNB configures a plurality of serving cells having different UL/DL configurations for the UE, the eNB may schedule downlink retransmission in a specific serving cell by downlink signaling in another sering cell. That is, downlink retransmission in a scheduled cell may be scheduled by transmitting a downlink signal in a scheduling cell.

The downlink signal transmitted in the scheduling cell may be a DL assignment for a DL retransmission or a PDCCH indicating a DL retransmission.

Or, the downlink signal transmitted in the scheduling cell may be a DL assignment for a DL retransmission for a serving cell that is configured with schedulingCellId, a PDCCH on a scheduling cell indicating a DL retransmission for another serving cell, or a PDCCH on a scheduling cell indicating a DL retransmission for a serving cell that is configured with schedulingCellId. Herein, the serving cell that is configured with schedulingCellId refers to the specific serving cell, that is, the scheduled cell.

In addition, the downlink signal may be a PDCCH with a Carrier Indicator Field (CIF).

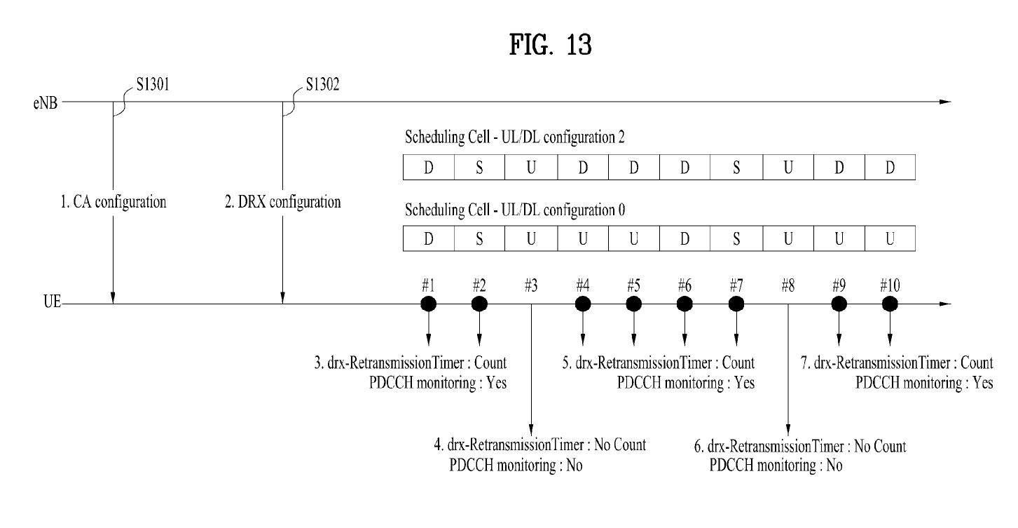

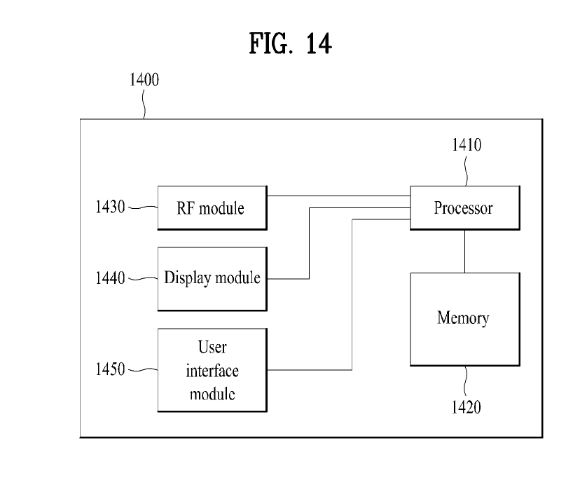

FIG. 13 illustrates an example of counting PDCCH-subframes to activate drx-RetransmissionTimer according to an embodiment of the present invention. Particularly, FIG. 13 illustrates an operation for counting drx-RetransmissionTimer in consideration of subframes available for reception of a DL assignment at a UE.

Referring to FIG. 13, a UE receives CA configuration information from an eNB in step 1301. For the convenience of description, it is assumed that the CA configuration information includes information indicating a UE uses two serving cells and a scheduled cell is controlled by cross-carrier scheduling. It is also assumed that the CA configuration information indicates that UL/DL configuration #2 applies to a scheduling cell and UL/DL configuration #0 applies to a scheduled cell.

In step 1302, the UE receives DRX configuration information from the eNB. The DRX configuration information may be received by an RRC signal being a higher-layer signal and may include information about a DRX-related timer.

In step 1303, since subframes #1 and #2 are PDCCH-subframes, the UE monitors a PDCCH in subframes #1 and #2. In addition, since subframes #1 and #2 are available for reception of a DL assignment in the scheduling cell, the UE counts subframes #1 and #2 by drx-RetransmissionTimer.

However, subframe #3 is not a PDCCH-subframe and thus the UE does not monitor a PDCCH in subframe #3 in step 1304. In addition, the UE does not count subframe #3 by drx-RetransmissionTimer because the UE may not receive a DL assignment in the scheduling cell in subframe #3.

In step 1305, the UE monitors a PDCCH in subframes #4 to #7 because subframe #4 is a PDCCH-subframe. Subframes #4 to #7 are also available for reception of radio resource information in the scheduling cell, the UE counts subframes #4 to #7 by drx-RetransmissionTimer. According to the conventional definition of drx-RetransmissionTimer, subframes #4 and #5 are uplink subframes unavailable for downlink data transmission in the scheduled cell. Therefore, subframes #4 and #5 are not counted by drx-RetransmissionTimer. However, subframes #4 and #5 are counted by drx-RetransmissionTimer in the present invention to thereby reduce power consumption of the UE.

As in step 1304, since subframe #8 is not a PDCCH-subframe, the UE does not monitor a PDCCH in subframe #8 in step 1306. In addition, the UE does not count subframe #8 by drx-RetransmissionTimer because the UE may not receive a DL assignment in the scheduling cell in subframe #8.

In step 1307, the UE monitors a PDCCH in subframes #9 and #10 because subframes #9 and #10 are PDCCH-subframes. Subframes #9 and #10 are also available for reception of radio resource information in the scheduling cell, the UE counts subframes #9 and #10 by drx-RetransmissionTimer. According to the conventional definition of drx-RetransmissionTimer, subframes #9 and #10 are uplink subframes unavailable for downlink data transmission in the scheduled cell. Therefore, subframes #9 and #10 are not counted by drx-RetransmissionTimer. However, subframes #9 and #10 are counted by drx-RetransmissionTimer in the present invention, thus expiring drx-RetransmissionTimer earlier than is conventionally done.

FIG. 14 is a block diagram of a communication apparatus 1400 according to an embodiment of the present invention.

Referring to FIG. 14, the communication apparatus 1400 includes a processor 1410, a memory 1420, a radio frequency (RF) module 1430, a display module 1440, and a user interface module 1450.

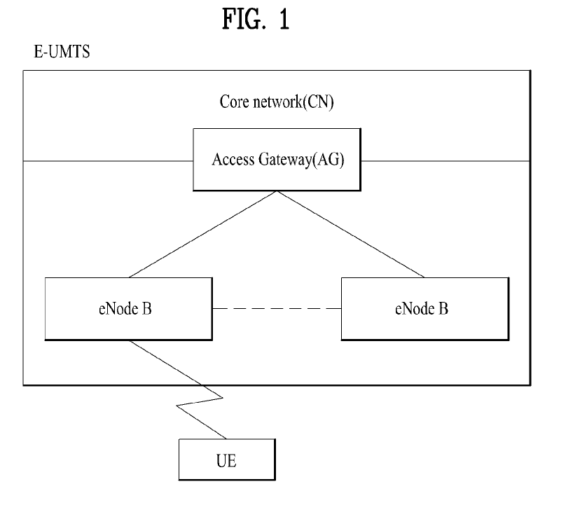

The communication apparatus 1400 is shown for convenience of description and some modules thereof may be omitted. In addition, the communication apparatus 1400 may further include necessary modules. In addition, some modules of the communication apparatus 1400 may be subdivided. The processor 1410 is configured to perform an operation of the embodiment of the present invention described with reference to the drawings. For a detailed description of the operation of the processor 1410, reference may be made to the description associated with FIGS. 1 to 13.

The memory 1420 is connected to the processor 1410 so as to store an operating system, an application, program code, data and the like. The RF module 1430 is connected to the processor 1410 so as to perform a function for converting a baseband signal into a radio signal or converting a radio signal into a baseband signal. To this end, the RF module 1430 performs analog conversion, amplification, filtering and frequency up-conversion or inverse processes thereof. The display module 1440 is connected to the processor 1410 so as to display a variety of information. As the display module 1440, although not limited thereto, a well-known device such as a liquid crystal display (LCD), a light emitting diode (LED), or an organic light emitting diode (OLED) may be used. The user interface module 1450 is connected to the processor 1410 and may be configured by a combination of well-known user interfaces such as a keypad and a touch screen.

The embodiments of the present invention described above are combinations of elements and features of the present invention. The elements or features may be considered selective unless otherwise mentioned. Each element or feature may be practiced without being combined with other elements or features. Further, an embodiment of the present invention may be constructed by combining parts of the elements and/or features. Operation orders described in embodiments of the present invention may be rearranged. Some constructions of any one embodiment may be included in another embodiment and may be replaced with corresponding constructions of another embodiment. It is obvious to those skilled in the art that claims that are not explicitly cited in each other in the appended claims may be presented in combination as an embodiment of the present invention or included as a new claim by subsequent amendment after the application is filed.

The embodiments of the present invention may be achieved by various means, for example, hardware, firmware, software, or a combination thereof. In a hardware configuration, an embodiment of the present invention may be achieved by one or more ASICs (application specific integrated circuits), DSPs (digital signal processors), DSDPs (digital signal processing devices), PLDs (programmable logic devices), FPGAs (field programmable gate arrays), processors, controllers, microcontrollers, microprocessors, etc.

In a firmware or software configuration, an embodiment of the present invention may be implemented in the form of a module, a procedure, a function, etc. Software code may be stored in a memory unit and executed by a processor. The memory unit is located at the interior or exterior of the processor and may transmit and receive data to and from the processor via various known means.

It will be apparent to those skilled in the art that various modifications and variations can be made in the present invention without departing from the spirit or scope of the invention. Thus, it is intended that the present invention cover the modifications and variations of this invention provided they come within the scope of the appended claims and their equivalents.

What is claimed is:

1. A method for operating a timer at a user equipment in a Time Division Duplex (TDD) communication system, the method comprising:
configuring a DRX (Discontinuous Reception) retransmission timer; and
starting the DRX retransmission timer to monitor consecutive PDCCH (Physical Downlink Control CHannel) subframes,
wherein the DRX retransmission timer specifies the maximum number of the consecutive PDCCH-subframes until a DL (Downlink) retransmission is received in aggregated cells.

2. The method of claim 1, further comprising:
stopping monitoring the consecutive PDCCH-subframes when the DRX retransmission timer is not running.

3. The method of claim 1, further comprising:
stopping the DRX retransmission timer when the DL retransmission is received in the aggregated cells.

4. The method of claim 1, wherein a number of consecutive PDCCH-subframes is counted regardless of a type of a subframe in the aggregated cells.

5. The method of claim 4, wherein the type of the subframe indicates whether the subframe is a downlink subframe, a special subframe or an uplink subframe.

6. The method of claim 1, wherein subframe configurations of the aggregated cells are different from each other.

7. The method of claim 1, further comprising:
receiving information on the DRX retransmission timer via a RRC (Radio Resource Control) layer signaling from the network.

8. The method of claim 1, wherein the PDCCH-subframes are subframes with the PDCCH in all cells except for at least one cell configured with an identity of a scheduling cell.

9. The method of claim 1, further comprising:
starting the DRX retransmission timer when decoding of data received in the aggregated cells are failed.

10. The method of claim 1, wherein the PDCCH-subframes are subframes on which the one or more PDCCHs are monitored.
